(19) United States
(12) Patent Application Publication
(10) Pub. No.: US 2022/0070688 A1
(43) Pub. Date: Mar. 3, 2022

(54) ADAPTATION OF A BEAM SWEEP IN A COMMUNICATIONS NETWORK

(71) Applicant: Telefonaktiebolaget LM Ericsson (publ), Stockholm (SE)

(72) Inventors: Peter ÖKVIST, Luleå (SE); Anders LANDSTRÖM, Boden (SE); Arne SIMONSSON, Gammelstad (SE); Kjell LARSSON, Luleå (SE)

(21) Appl. No.: 17/415,930

(22) PCT Filed: Dec. 28, 2018
(86) PCT No.: PCT/SE2018/051373

§ 371 Date: Jun. 18, 2021

(51) Int. Cl. H04W 16/28; H04B 7/06; H04W 64/00

(52) U.S. Cl. CPC H04W 16/28; H04W 64/006; H04B 7/0617

(57) ABSTRACT

There is presented a method for a network node, or for a user equipment, for adapting a beam sweep in a communications network. The communications network includes the network node, a transmission point, TP, and a user equipment, UE. The method includes determining at least one parameter related to the angular speed of the UE relative to the transmission point. The method further includes adapting at least one parameter associated with the beam sweep based on the parameter related to the angular speed.

Embodiments presented herein relate to a method for a network node, a network node, a method for a UE, a UE, a computer program, and a computer program product for adapting a beam sweep in a communications network.

### BACKGROUND

The 5G NR (New Radio) is the latest in the series of 3GPP standards which supports very high data rate and with lower latency compare to its predecessor LTE (4G) and 3G/2G technology. In 5G NR, massive multiple input multiple output (MIMO) has become a key technology and therefore beam based cell sector coverage is used, which increases the link budget and overcomes the disadvantages of the mm-wave channel. In other words, all the data transmissions and control signalling transmissions are beam-formed. In an exemplary massive MIMO system there will be about 20 different beams transmitted to cover the 120 degrees cell sector.

Beam management procedures are used in 5G NR to acquire and maintain a set of transmission and reception points and/or UE beams which can be used for downlink (DL) and uplink (UL) transmission/reception. Beam management includes for example beam sweeping, beam measurements, beam determination and beam failure recovery but it is not limited thereto. The time during which a beam is the best choice to use depends on the time it takes to pass the beams coverage area. It is important to determine when another beam becomes a better choice, it is especially important to detect this before the currently used beam have deteriorated too much. Beam sweeping refers to covering a spatial area with a set of beams transmitted and received according to pre-specified intervals and directions. Beam measurement refers to evaluation of the quality of the received signal at the gNB or at the UE. Different metrics could be used such as Reference Signal Received Power (RSRP), Reference Signal Received Quality (RSRQ) and Signal to Interference & Noise Ratio (SINR) or Signal to Noise Ration (SNR) for this purpose.

Beam management is and will be an important topic for Advanced Antenna Systems (AAS) in 5G NR and LTE. Beam management needs to assure that that resources are used efficiently and to minimize the waste of resources such as air resources and transmission power. To ensure robust performance, for example, selecting the optimal beam, the communications system is designed to handle the ‘worst case scenario’. However, designing the communications system such that it can ensure robust performance also under ‘worst case scenario’ requires a lot of signaling and radio resources. The ‘worst case scenario’ is not that common and hence resources will be wasted for a large fraction of the time the system is used.

Hence, there is still a need for an improved beam sweeping.

### SUMMARY

According to a first aspect there is presented a method for a network node for adapting a beam sweep in a communications network, the communications network includes the network node, a transmission point, TP, and a user equipment, UE. The method includes determining at least one parameter related to the angular speed of the UE relative to the transmission point. The method further includes adapting at least one parameter associated with the beam sweep based on the parameter related to the angular speed.

According to a second aspect there is presented a network node including processing circuitry configured to adapt a beam sweep in a communications network, the communications network including the network node, a transmission point, TP, and a user equipment, UE. The processing circuitry is further configured to determine at least one parameter related to the angular speed of the UE relative to the transmission point. Furthermore, the processing circuitry is configured to adapt at least one parameter associated with the beam sweep based on the parameter related to the angular speed.

According to a third aspect there is presented a method for a user equipment, UE, for adapting a beam sweep in a communications network (100a), the communications network comprising a network node, a transmission point, TP, and the user equipment, UE. The method includes determining at least one parameter related to the angular speed of the UE relative to the transmission point. The method further includes adapting at least one parameter associated with the beam sweep based on the parameter related to the angular speed.

According to a fourth aspect there is presented a user equipment including processing circuitry configured to adapt a beam sweep in a communications network, the communications network including a network node, a transmission point, TP, and the user equipment, UE. The processing circuitry is further configured to determine at least one parameter related to the angular speed of the UE relative to the transmission point. Furthermore, the processing circuitry is configured to adapt at least one parameter associated with the beam sweep based on the parameter related to the angular speed.

According to a fifth aspect there is presented a computer program for adapting a beam sweep in a communications network, the computer program comprising computer program code which, when run on a network node, causes the radio transceiver device to perform a method according to the first aspect.

According to a sixth aspect there is presented a computer program for adapting a beam sweep in a communications network, the computer program comprising computer program code which, when run on a user equipment, causes the user equipment to perform a method according to the third aspect.

According to a seventh aspect there is presented a computer program product comprising a computer program according to the fifth or the sixth aspect and a computer readable storage medium on which the computer program is stored. The computer readable storage medium could be a non-transitory computer readable storage medium.

Advantageously these methods, this user equipment, this network node, this computer program, and this computer program product enables adapting a beam sweep in a communications network.

Advantageously the adapting the beam sweep based on determined at least one parameter related to the angular speed of the UE relative to the transmission point.

Advantageously these methods, this user equipment, this network node, this computer program, and this computer program product adapts the beam sweep such that only the amount of resources, for example data associated with the beam management such as RSRP, RSRQ, SINR, SNR, CSI-RS, CSI reports and SRS that are necessary to maintain a robust system performance is transmitted between the user equipment and the network node. The avoidance of unnecessary transmission of beam management related data will also save energy, increase the amount of data resources available for user data, and reduce the amount of interference to neighboring cells.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating communications networks according to embodiments;

FIG. 2 illustrates beam sweep when input to beam managements is provided at a high rate or high frequency (2a) and at a low rate or low frequency (2b).

FIG. 3 illustrates beam sweep when input to beam managements is provided at a rate or frequency that is adapted based on an estimation of the distance between the UE and the transmission point;

FIG. 4 is a flowchart of methods according to embodiments;

FIG. 5 is a schematic diagram showing functional units of a network node according to an embodiment;

FIG. 6 is a schematic diagram showing functional units of a user equipment according to an embodiment;

FIG. 7 illustrates beam sweep when input to beam managements is provided at a rate or frequency that is adapted based on an estimation of the distance between the UE and the transmission point and/or on an estimation of the velocity at which the UE is moving;

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

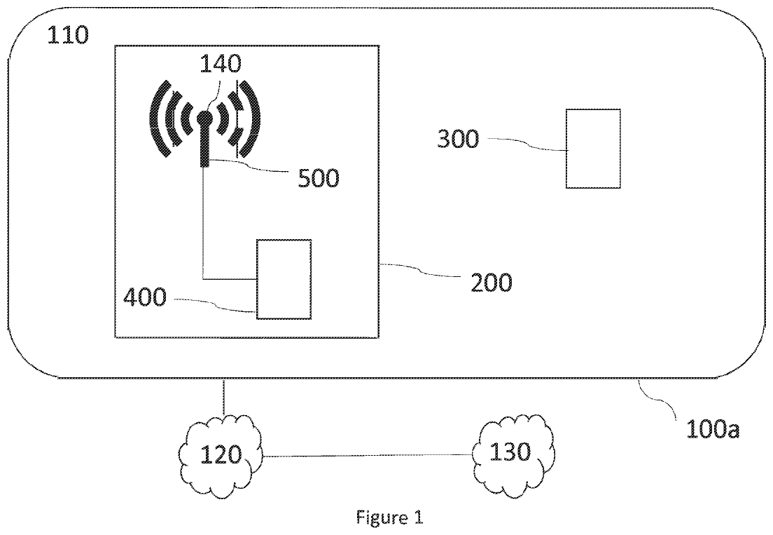

FIG. 1 is a schematic diagram illustrating a communications network 100a where embodiments presented herein can be applied. The communications network 100a could be a third generation (3G) telecommunications network, a fourth generation (4G) telecommunications network, or a fifth (5G) telecommunications network and support any 3GPP telecommunications standard.

The communications network 100a comprises a transmission point, TP, 140 including an antenna device 500 which may be a Multiple-Input Multiple-Output (MIMO) antenna including two or more antennas. The antenna device 500 is connected to a radio device 400. The communications network 100a further includes the network node 200 may include one or more TPs. The network node is configured to, in a radio access network 110, provide network access to an user equipment, UE, 300. The radio access network 110 is operatively connected to a core network 120. The core network 120 is in turn operatively connected to a service network 130, such as the Internet. The UE 300 is thereby, via network node and the transmission point 140, enabled to access services of, and exchange data with, the service network 130. Examples of network nodes are radio access network nodes, radio base stations, base transceiver stations, Node Bs, evolved Node Bs, g Node Bs, access points, access nodes, antenna integrated radios (AIRs), and transmission and reception points (TRPs). Examples of UEs are, terminal devices, wireless devices, mobile stations, mobile phones, handsets, wireless local loop phones, smartphones, laptop computers, tablet computers, network equipped sensors, network equipped vehicles, and so-called Internet of Things devices.

The network node 200 provides network access in the radio access network 110 by transmitting signals to, and receiving signals from, the UE 300 using beams. The signals could be transmitted from, and received by, a network node 200, using a transmission and reception points.

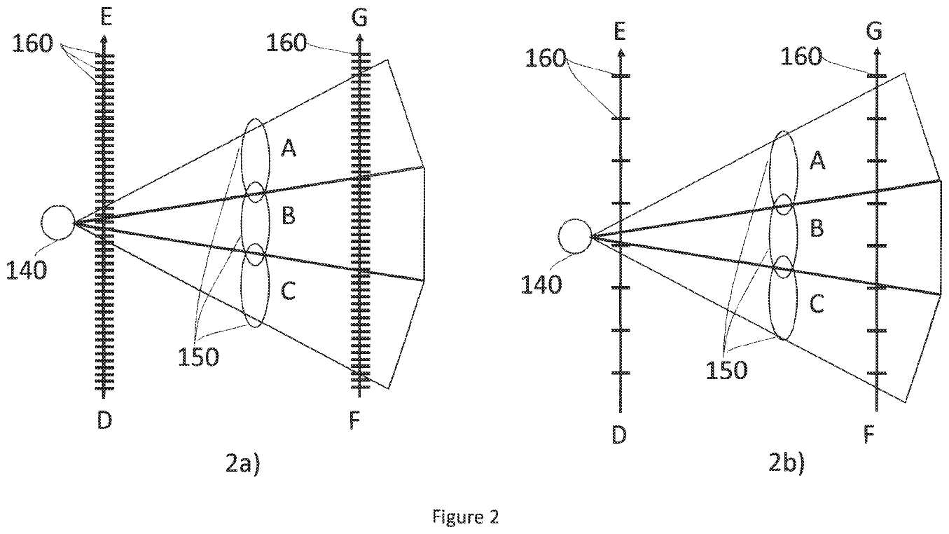

A UE moving from point D to point E in FIGS. 2a and 2b would be served be three different beams, one beam in sector A, one beam in sector B and one beam in sector C. A UE moving from point F to point G would also be served by three different beams, one in sector A, one in sector B and one in sector C. However, as can be seen from FIG. 2, a UE moving from point D to point E will be closer to the transmission point compared to a UE moving from point F to G. A UE moving between D and E will therefore spend less time being served by each individual beam 150 compared to a UE moving between F and G, under the assumption the UE is moving at the same speed between point D to point E and between point F to point G.

Beam sweeping is performed to find a suitable beam for the UE within the set of beams and is directed to the operation of covering a spatial area, such as one of the sectors in FIGS. 2, 3 and 7, with beams transmitted from a transmission point 140 during a time interval in a predefined way. When moving between the sectors, the UE changes the serving beam. In one embodiment the UE or the network performs beam measurement to determine which beam that is currently the most advantageous to use. This beam determination may be based on beam measurements. The beam determination refers to the selection of the suitable beam or beams either at the network node or at the UE, according to the measurements obtained with the beam measurements. Beam measurements during a beam sweep may refer to evaluation of the quality of the received signal at the network node or at the UE. Different metrics could be used such as RSRP, RSRQ and SINR or SNR for this purpose but the embodiments herein are not limited thereto. Other relevant metrics may include references signals such as (CSI-RS), measurement reports such as CSI reports and/or uplink/downlink sounding references signals (SRS), where some of the metric may be periodic, aperiodic or event driven.

While the terminal device is moving from point D to point E in FIG. 2 it will provide input to beam management at points or instances 160. The input to beam management may include beam measurements. Under the assumption that the inputs 160 to beam management are given at the same frequency, i.e. at the same rate, a UE when moving from D to E would then provide input to beam management at far less occasion as compared to when moving from F to G, if moving at the same speed between D and E and between F and G. In FIG. 2b it can be seen that if rate with which input is given to beam management is low then there may be occasion where no input is given to beam management. In the embodiment of FIG. 2b no input is provided in sectors A and B when the UE is moving between D and E. When the UE is moving between D and E is will be closer to the transmission point compared to moving the distance between F and G. Whereas, when the UE is moving between F and G, which is further away from the transmission point 140, there will be several occasions during which the UE can provide input. The assumption in FIG. 2 is the terminal device is moving between D and E, and between F and G at the same speed.

However, as shown in FIG. 2a when the UE is moving from F to G is that the UE may provide input to beam management too often, i.e. the input to beam management is provided more often than need and this may result in a waste of energy and will also waste data resources. Providing input too often may also result in an unnecessary increase in interference between neighboring cells.

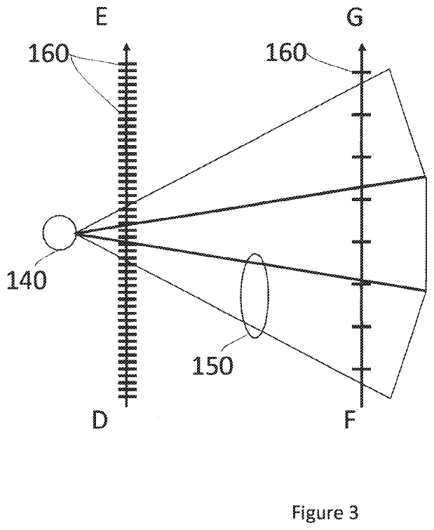

FIG. 3 shows an embodiment where the rate at which the UE provides input to beam management 160 is higher when the UE is moving between D and E than the rate at which the UE provides input to beam management 160 when moving between F and G. The assumption in FIG. 3 is the terminal device is moving between D and E, and between F and G at the same speed. The rate at which the UE provides input to beam management is adapted depending on the distance between the terminal device and the transmission point. Thus, the rate of beam measurements 160 during a beam sweep is adapted based on the UE angular velocity relative the transmission point. The shorter the distance between the transmission point and the UE, i.e. the higher the angular velocity of the UE relative to the TP, the higher the rate or frequency at which the terminal device provides input to beam management. The longer the distance between the transmission point and the terminal device, as illustrated when the terminal device is moving between F and G, the lower the rate or frequency at which the terminal device provides input to beam management.

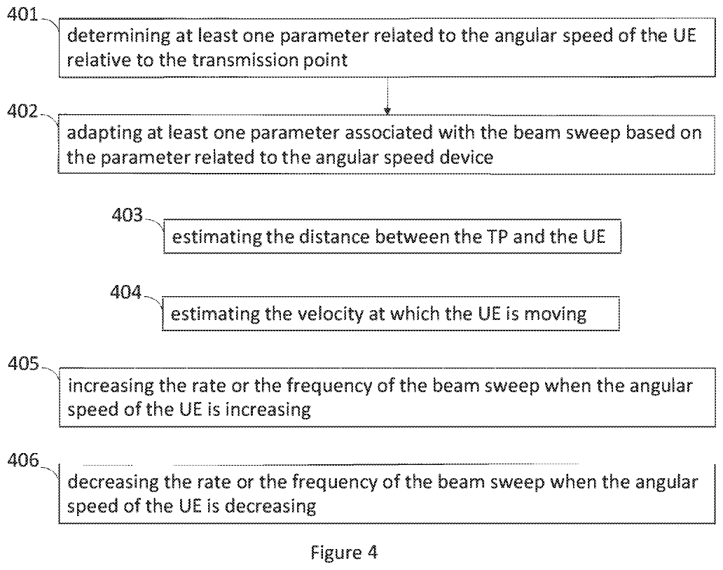

Step 401 in FIG. 4 is directed to the network node, or the UE, determining at least one parameter related to the angular speed of the UE relative to the transmission point. In some embodiments the angular speed may be estimated as change of Angle-of-Arrival. Angle-of-arrival may be obtained from the received signal time difference between different antennas. Angular speed can also be estimated from the time a UE stays within a single beam.

Determining the at least one parameter related to the angular speed of the UE may include estimating the distance between the TP and the UE, step 403. The angular velocity of a UE relative to the transmission point is dependent on the distance between the UE and the TP. For example, a UE moving with the same speed between D and E will have a higher angular velocity compared to a UE moving between F and G, in FIG. 2. The distance may be estimated by obtaining the GPS coordinates for the UE. This may include that the GPS coordinates for the UE are detected and then transmitted to the network node. Another way of estimating the distance between the UE and the network node includes measuring the signal strength for the communication between the network node and the UE. The strength of a signal is in some embodiments inversely proportional to the distance between the UE and the network node. Another parameter that may be used for estimating the distance between the UE and network node is the timing advance value for the communication between the network node and the UE. Timing advance is a timing offset, at the UE, between the start of a received downlink subframe and a transmitted uplink subframe. This offset at the UE is necessary to ensure that the downlink and uplink subframes are synchronised at the network node. A UE far from the network node encounters a larger propagation delay so its uplink transmission is somewhat in advance as compared to a UE closer to the network node. The timing advance (TA) is equal to 2× propagation delay assuming that the same propagation delay value applies to both downlink and uplink directions. The pointing direction of the beam used for the beam sweep may also be used to estimate the distance. In some embodiments the pointing direction of the beam is an indication how close or how far away the UE is from the network node. Beams pointing downwards are more likely to serve UEs that are closer to the TP than beams pointing towards the horizon. Beams pointing towards the horizon are more likely to serve UEs that are more far away than beams that are pointing downwards. Thus, the frequency of the beam sweep can be reduced for beams pointing towards the horizon as compared to beams pointing in a more downward direction. Therefore, by pure geometrical consideration the pointing angle of the beam is an estimation of the distance between the UE and the network node.

In step 404, determine the at least one parameter related to the angular speed of the UE includes estimating the velocity at which the UE is moving. A UE moving at higher velocity relative to the transmission point will also have a higher angular velocity relative to the transmission point compared to a UE moving at lower velocity. The velocity of the UE can be estimated using Doppler measurements or by obtaining changes in the timing advance value. Another way estimating the velocity of the UE is to measure the time a UE stays within a single beam. For example, referring to FIG. 2, the time the UE is in sector B is an estimation of the velocity. Further, the by obtaining the location of the UE at different occasion using GPS may also be used to estimate the velocity.

In step 402 at least one parameter associated with the beam sweep is adapted based on the parameter related to the angular speed device. The at least one parameter associated with the beam sweep may include adapting the rate or the frequency of the beam sweep, e.g. adapting the rate or frequency may include adapting the rate of the frequency of the beam measurements during a sweep. Adapting at least one parameter associated with the beam sweep could may also include adapting rate or frequency at which the UE provides input to beam management. In step 405 the rate or the frequency of the beam sweep increases when the angular speed of the UE is increasing. In step 406 the rate or the frequency of the beam sweep decreases when the angular speed of the UE is decreasing. Increasing or decreasing the rate or the frequency of the beam sweep may include increasing or decreasing how often the UE provides input to beam management 160. Increasing or decreasing the rate or the frequency of the beam sweep may also include increasing or decreasing the rate of frequency of beam measurements 160 during the beam sweep. The parameter that is adapted may also include the frequency with which the reference signals such as CSI-RS is sent to the UE, the frequency with which measurements reports such as CSI reports are sent, the frequency with which the uplink SRS are sent from the UE to the network node, the frequency with which the UE measures the reference signals; and/or the frequency with which the UE reports measurements of reference signals. The frequency may some embodiment refer to how often these parameters are reported.

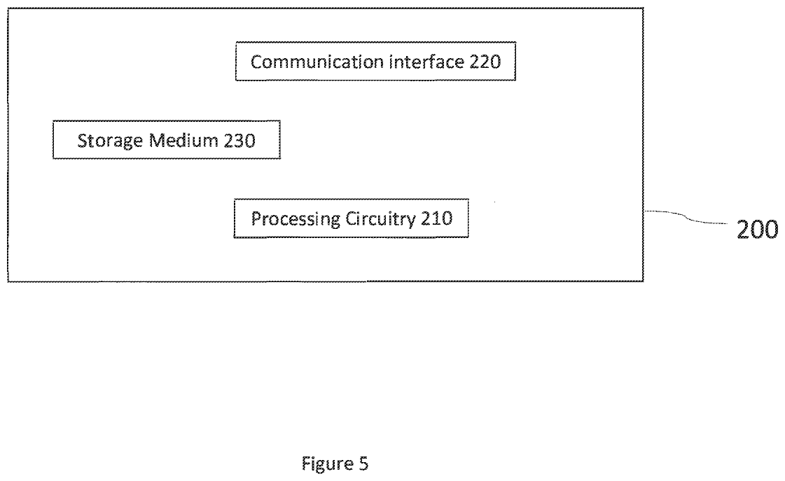

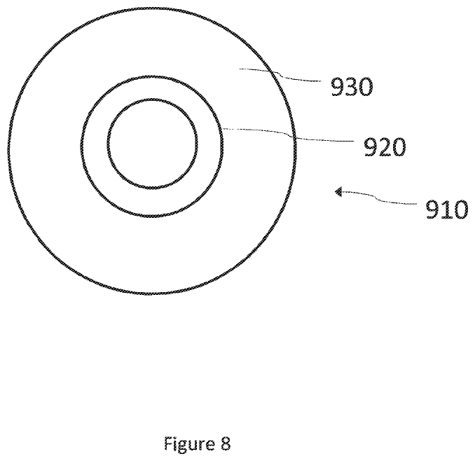

FIG. 5 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 8), e.g. in the form of a storage medium 230 or memory. The processing circuitry 210 may further be provided as at least one application specific integrated circuit (ASIC), or field programmable gate array (FPGA).

Particularly, the processing circuitry 210 is configured to cause network node 200 to perform a set of operations, or steps, 401-406, as disclosed above. For example, the storage medium or memory 230 may store the set of operations, and the processing circuitry 210 may be configured to retrieve the set of operations from the storage medium 230 to cause network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. Network node 200 may further comprise a communications interface 220 at least configured for communications with other nodes, device, functions, and notes of the communications network 100a. As such the communications interface 220 may comprise one or more transmitters and receivers, comprising analogue and digital components. Signals could be transmitted from, and received by, a network node 200 using the communications interface 220.

The processing circuitry 210 controls the general operation of network 200 e.g. by sending data and control signals to the communications interface 220 and the storage medium 230, by receiving data and reports from the communications interface 220, and by retrieving data and instructions from the storage medium 230. Other components, as well as the related functionality, of network node 200 are omitted in order not to obscure the concepts presented herein.

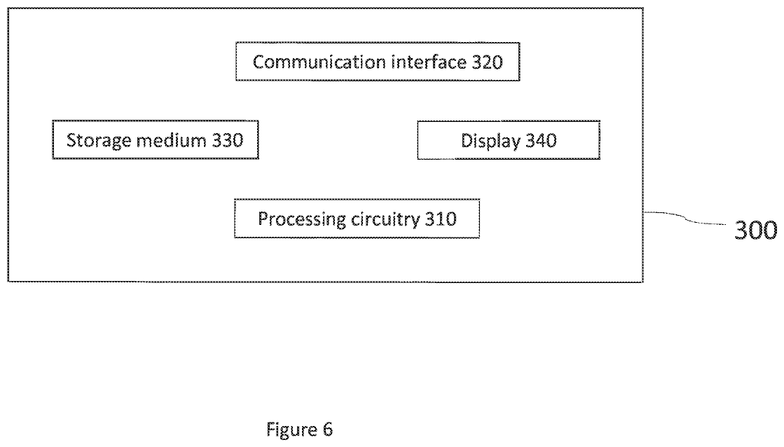

FIG. 6 schematically illustrates, in terms of a number of functional units, the components of a UE 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 910 (as in FIG. 8), e.g. in the form of a storage medium 330 or memory. The processing circuitry 310 may further be provided as at least one application specific integrated circuit (ASIC), or field programmable gate array (FPGA).

Particularly, the processing circuitry 310 is configured to cause UE 300 to perform a set of operations, or steps, 401-406, as disclosed above. For example, the storage medium or memory 330 may store the set of operations, and the processing circuitry 310 may be configured to retrieve the set of operations from the storage medium 330 to cause UE 300 to perform the set of operations. The set of operations may be provided as a set of executable instructions.

Thus the processing circuitry 310 is thereby arranged to execute methods as herein disclosed. The storage medium 330 may also comprise persistent storage, which, for example, can be any single one or combination of magnetic memory, optical memory, solid state memory or even remotely mounted memory. UE 300 may further comprise a communications interface 320 at least configured for communications with other nodes, device, functions, and notes of the communications network 100a. As such the communications interface 320 may comprise one or more transmitters and receivers, comprising analogue and digital components. Signals could be transmitted from, and received by, a UE 300 using the communications interface 320.

The processing circuitry 310 controls the general operation of UE 300 e.g. by sending data and control signals to the communications interface 320 and the storage medium 330, by receiving data and reports from the communications interface 320, and by retrieving data and instructions from the storage medium 330. Optionally the UE may include a display 340 but the embodiments herein are not limited thereto. Other components, as well as the related functionality, of UE 300 are omitted in order not to obscure the concepts presented herein.

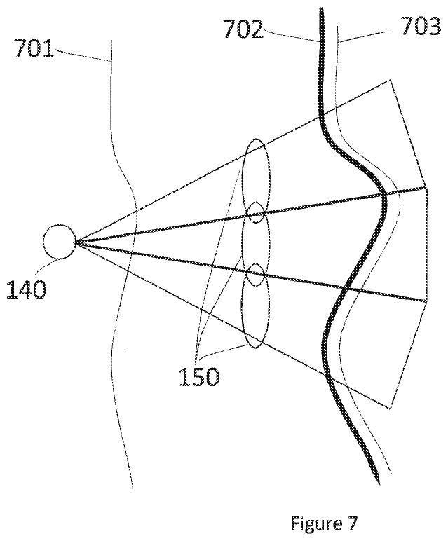

FIG. 7 illustrate embodiments where vehicles are passing at high speed in the middle of cell, which may include an area between the transmission point 140 and the reach of the beams 150. In the embodiments of FIG. 7 the least one parameter associated with the beam sweep is adapted based on the distance between the UE and the TP and/or based on the speed at which the UE is moving. Speed information can come from e.g. Doppler measurements, changes in timing advance value, the time a UE is served by a beam, GPS readings, etc. Beam sweeps can be adjusted based on a combination of speed and distance estimations, where the estimations may be according to the other embodiments disclosed herein. A pedestrian walking with a UE on the pathway 701 is closer than to the TP compared to pedestrian walking on the pathway 703 and therefor the beam sweep is adapted such that the rate of the beam sweep is faster for the pedestrian walking on the pathway 701. Further for a UE in vehicle, or included in the vehicle, driving on the road 702 which is at the same distance from the TP as the pathway 703, the beam sweep is adapted such that it is faster as compared to the UE moving on the pathway 703 because the UE moving on the road 702 is moving at a higher speed relative to the transmission point. The angular speed, the estimation of the speed or distance of the UE relative to the TP 140 of FIG. 7 may be obtained according to steps 401-408. Machine learning or fingerprinting techniques can be used to refine identification of such characteristics in the cell.

FIG. 8 shows one example of a computer program product 910 comprising computer readable storage medium 930. On this computer readable storage medium 930, a computer program 920 can be stored, which computer program 920 can cause the processing circuitry 210 or 310 and thereto operatively coupled entities and devices, such as the communications interface 220 or 320 and the storage medium 230 or 330, to execute methods according to embodiments described herein. The computer program 920 and/or computer program product 910 may thus provide means for performing any steps as herein disclosed.

In the example of FIG. 8, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for a network node for configuring a beam sweep in a communications network, the communications network comprising the network node, a transmission point, TP, and a user equipment, UE, the method comprising:
determining at least one parameter related to an angular speed of the UE relative to the transmission point; and
configuring at least one parameter associated with the beam sweep based on the parameter related to the angular speed.

2. The method according to claim 1, where determining the at least one parameter related to the angular speed of the UE comprises estimating the angular speed by one or more of:
measuring a change in angle-of-arrival of a signal received from the UE; and
measuring a time a UE stays within a single beam.

3. The method according to claim 1, where determining the at least one parameter related to the angular speed of the UE comprises:
estimating a distance between the TP and the UE.

4. The method according to claim 3, where estimating the distance between the TP and the UE comprises one or more of:
obtaining GPS coordinates for the UE;
measuring a signal strength for the communication between the network node and the UE;
obtaining a timing advance value for the communication between the network node and the UE; and
determining a pointing direction of the beam used for beam sweep.

5. The method according to claim 1, where determining the at least one parameter related to the angular speed of the UE comprises:
estimating a velocity at which the UE is moving.

6. The method according to claim 5, where estimating the velocity of the UE comprises one or more of:
Doppler measurements;
obtaining changes in a timing advance value;
measuring a time a UE stays within a single beam; and
obtaining GPS coordinates of the UE that allows determining the velocity.

7. The method according to claim 1, where configuring at least one parameter associated with the beam sweep comprises configuring one of a rate or a frequency of the beam sweep.

8. The method according to claim 1, where configuring at least one parameter associated with the beam sweep comprises configuring one or more of:
a frequency with which reference signals are sent to the UE;
a frequency with which measurements reports are sent;
a frequency with which uplink SRS are sent from the UE to the network node;
a frequency with which the UE measures the reference signals; and
a frequency with which the UE reports measurements of reference signals.

9. The method according to claim 7, where configuring at least one parameter associated with the beam sweep comprises one of:
increasing one of the rate and the frequency of the beam sweep frequency when the angular speed of the UE is increase; and
decreasing one of the rate and the frequency of the beam sweep frequency when the angular speed of the UE is decreases.

10. A network node comprising processing circuitry configured:
determine at least one parameter related to an angular speed of a user equipment, UE, relative to the transmission point; and
configure at least one parameter associated with a beam sweep based on the parameter related to the angular speed.

11. A method for a user equipment, UE, for configuring a beam sweep in a communications network, the communications network comprising the network node, a transmission point, TP, and a user equipment, UE, the method comprising:
determining at least one parameter related to an angular speed of the UE relative to the transmission point; and
configuring at least one parameter associated with the beam sweep based on the parameter related to the angular speed.

12. The method according to claim 10, where determining the at least one parameter related to the angular speed of the UE comprises estimating the angular speed by measuring a time a UE stays within a single beam.

13. The method according to claim 11, where determining the at least one parameter related to the angular speed of the UE comprises:
estimating a distance between the TP and the UE.

14. The method according to claim 13, where estimating the distance between the TP and the UE comprises one or more of:
obtaining the GPS coordinates for the UE;
measuring a signal strength for the communication between the network node and the UE; and
obtaining a timing advance value for the communication between the network node and the UE.

15. The method according to claim 11, where determining the at least one parameter related to the angular speed of the UE comprises:
estimating a velocity at which the UE is moving.

16. The method according to claim 15, where estimating the velocity of the UE comprises one or more of:
Doppler measurements;
obtaining changes in a timing advance value; and
obtaining GPS coordinates of the UE that allows determining the velocity.

17. The method according to claim 11, where configuring at least one parameter associated with the beam sweep comprises configuring one of a rate and a frequency of the beam sweep.

18. The method according to claim 11, where configuring at least one parameter associated with the beam sweep comprises configuring one or more of:
a frequency with which measurements reports are sent;
a frequency with which uplink SRS are sent from the UE to the network node;
a frequency with which the UE measures reference signals; and
a frequency with which the UE reports measurements of the reference signals.

19. The method according to claim 17, where configuring at least one parameter associated with the beam sweep comprises one of:
increasing one of the rate and the frequency of the beam sweep frequency when the angular speed of the UE increases; and
decreasing one of the rate and the frequency of the beam sweep frequency when the angular speed of the UE decreases.

20. A user equipment, UE, comprising processing circuitry configured to:
determine at least one parameter related to an angular speed of the UE relative to the transmission point; and
configure at least one parameter associated with a beam sweep based on the parameter related to the angular speed.

21. (canceled)

22. (canceled)
